(19) United States
(12) Patent Application Publication
(10) Pub. No.: US 2015/0269586 A1
(43) Pub. Date: Sep. 24, 2015

(54) Method and System for Crowd-Sourcing Customer Care

(71) Applicant: Cellco Partnership d/b/a Verizon Wireless, Basking Ridge, NJ (US)

(72) Inventors: Heera Singh Garia, Alpharetta, GA (US); Ram Kumar, Woodstock, GA (US)

(73) Assignee: Cellco Partnership d/b/a Verizon Wireless, Basking Ridge, NJ (US)

(21) Appl. No.: 14/217,579

(22) Filed: Mar. 18, 2014

(51) Int. Cl. G06Q 30/00

(52) U.S. Cl. CPC G06Q 30/016

(57) ABSTRACT

A method and system are disclosed that enables crowd-sourcing of customer care. The disclosed crowd sourcing system may use a diverse workforce, including a business's customer base, an online community, and an employee base. The exemplary crowd-sourcing system may use a service level agreement for the crowd care providers that includes a time constraint period during which the crowd care provider may submit a response to a customer request. Customer requests may be routed to one or more particular crowd care providers or crowd care tiers, whose expertise and/or experience may be taken into account during such routing. In this manner, customer requests may be resolved in a timely fashion without relying solely on an employee base.

### FIELD OF THE INVENTION

The field of the present invention relates generally to a method and system for crowd-sourcing customer care.

### BACKGROUND

Crowdsourcing is the concept of outsourcing a function to a community of users who then voluntarily perform the function. Crowdsourcing may involve problem solving by numerous people including experts, amateurs, or the general public. In effect, numerous people are mobilized to find and assemble information, and thereby create a collective resource. Various problems exist with traditional crowdsourcing, however, which limits its application to customer care. Some of these problems include lack of order in outsourcing to the various groups or individuals in the crowd; lack of time constraints with respect to the various groups or individuals; and inability to distinguish or discriminate based on qualities of the particular groups or individuals in a given crowd sourcing forum. The present invention overcomes some of the problems inherent in traditional crowdsourcing, and effectively leverages the concept of crowdsourcing to customer care.

### BRIEF DESCRIPTION OF THE DRAWINGS

FIG. 1 depicts a block diagram of a system architecture for sending data through a network, according to an exemplary embodiment;

FIG. 2 depicts a block diagram of an exemplary crowd care platform, according to an exemplary embodiment of the invention;

FIG. 3 depicts a block diagram showing an exemplary flow of information between a customer and the crowd care platform, according to an exemplary embodiment of the invention;

FIG. 4 depicts an illustrative flowchart of a request resolution process, according to an exemplary embodiment of the invention.

### DETAILED DESCRIPTION OF THE INVENTION

Reference will now be made in detail to exemplary embodiments, examples of which are illustrated in the accompanying drawings. It should be appreciated that the same reference numbers will be used throughout the drawings to refer to the same or like parts. The following description is intended to convey a thorough understanding of the embodiments described by providing a number of specific embodiments. It should be appreciated that the following detailed descriptions are exemplary and explanatory only and are not restrictive. As used herein, any term in the singular may be interpreted to be in the plural, and alternatively, any term in the plural may be interpreted to be in the singular.

The present invention leverages the concept of crowdsourcing and applies it to customer care. Typically, customer care involves a customer contacting a business representative, and then the business representative attempts to answer or solve the customer's inquiry. The crowd care model of customer care disclosed herein creates a new channel for customer care that effectively combines both traditional and social avenues for customer care in a novel way. Various advantages of the disclosed embodiments of the crowd care model include reducing the number of calls to business representatives, creating a platform to capture trends in customer issues, creation of a knowledge repository that can be used to resolve future customer inquiries, a reduction in average hold time for customers utilizing traditional customer care, increased ability to resolve customer inquiries upon the first contact, and increased customer satisfaction, to name a few.

The exemplary crowd care platform may use various elements or groups to achieve the advantages stated above. As explained in detail below, the exemplary crowd care platform may use a diverse workforce, an incentive model, a task flow model, and service level agreement(s). A diverse workforce may represent an expert community of users, a group of individuals, a company's employees, or a company's own customer base, for example, to solve a particular problem or answer an inquiry. An incentive model may represent a system for rewarding those who complete a crowd care task using points, perks, or other rewards, for example. A task flow model may represent steps in the business process from task inception to completion and acceptance or rejection of the task solution(s). The task flow model may relate to the lifecycle of the inquiry and may pertain to the person submitting the inquiry (e.g., the submitting customer or potential customer, or more generally, the requestor). There may also be one or more service level agreements, which may represent task contracts between some of, or all of, the requestor, the diverse workforce of crowd care providers, the crowd care platform, and/or the business running the crowd care platform. As used herein, the term “crowd” or “crowd care provider” may refer to an individual, a group, or a collection of people participating in the overall crowd care system by assisting in resolving an inquiry. An inquiry is generally referred to below as a request, and may comprise a question, a task, a troubleshooting issue, a problem, a complaint, a comment, or a combination of these, for example. A response to the inquiry or request is generally referred to below as a solution or proposed solution, but may comprise an answer, a confirmation, a (proposed) solution, an acknowledgment, a request for additional information, a general or specific response, or a combination of these, for example.

By utilizing service level agreement(s) and/or intelligent routing, the crowd-care platform is more than just a community forum or a social collaboration platform. A community forum may provide a platform where the online public community may pool information. Similarly, a social collaboration forum may provide a platform where a particular subscriber base may pool information. The exemplary crowd care platform disclosed herein, by contrast, provides a forum for the online public community, a customer base, and company employees, in combination with service level agreements and/or intelligent routing, to pool information in an efficient and intelligent manner for the purpose of quickly and correctly answering customer inquiries, improving customer satisfaction, and building a knowledge database that can be used by the company to answer current or future requests or to aid in other or future business endeavors.

The description below of the exemplary crowd care platform describes modules that may include one or more servers, databases, subsystems and other components. As used herein, the term “module” may be understood to refer to non-transitory executable software, firmware, processor, hardware, and/or various combinations thereof. Modules, however, are not to be interpreted as software that is not implemented on hardware, firmware, or recorded on a tangible processor-readable or recordable storage medium (i.e., modules are not software per se). The modules are exemplary. The modules may be combined, integrated, separated, and/or duplicated to support various applications and may be centralized or distributed. A function described herein as being performed at a particular module may be performed at one or more other modules and/or by one or more other devices instead of or in addition to the function performed at the particular module. The modules may be implemented across multiple devices and/or other components local or remote to one another. The devices and components that comprise one module may or may not be distinct from the devices and components that comprise other modules.

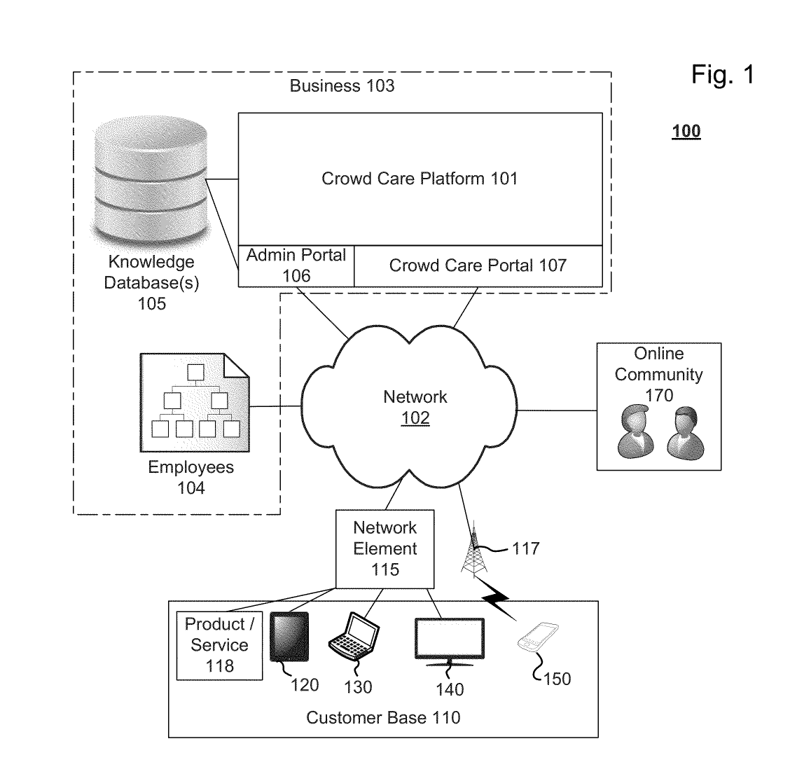

Referring to FIG. 1, a schematic diagram of a system 100 for establishing and running a crowd care platform is shown, according to an exemplary embodiment. As illustrated, network 102 may be communicatively coupled with one or more data transmitting devices, communities, entities, network element(s) 115, or wireless transceiver(s) 117. Various groups that may exchange data through network 102 include employees 104 of an entity such as a business 103, a customer base 110 of that business 103 or another business, and/or an online community 170 drawn from the general public, for example. Business 103 may be responsible for managing the crowd care platform 101, admin portal 105, crowd care portal 107, knowledge database(s) 105, employees 104, and/or products/services provided or offered to customer base 110. Employees 104 may be organized into various business units and/or according to a hierarchy based on seniority or expertise, for example. Employees 104 may include any type of employee within business 103, including customer service representatives, management, technological staff, product development staff, and/or marketing staff, for example.

Customer base 110 may represent current or potential customers of business 103, including any individual, group, entity, or agency that purchases products and/or services from business 103. The services provided by business 103 may or may not relate to products sold by business 103, and the products sold by business 103 may or may not relate to services provided by business 103. Exemplary products sold or serviced by business 103 may include a tablet computer 120, network client 130, video display device 140, or mobile device 150, for example. In the alternative, business 103 may be responsible for managing the crowd care platform and customer base 110 may represent the customer base of another business which provides services and/or products to such customer base.

Network client 130 may be a desktop computer, a laptop computer, a tablet, a server, a personal digital assistant, or other computer capable of sending or receiving network signals. Video display device 140 may be a television, monitor, set-top-box, projector, digital video recorder, or media player, for example. Mobile device 150 may be a mobile communications device, a smartphone, a tablet computer, a wearable computer such as in the form of a wrist watch or glasses, a health monitoring device, a home phone, a cellular phone, a mobile phone, a satellite phone, a personal digital assistant, a computer, a handheld multimedia device, a personal media player, a gaming device, a mobile television, or other devices capable of transmitting data and communicating directly or indirectly with network 102. Product 118, tablet computer 120, network client 130, video display device 140, or mobile device 150 may connect to network 102 and communicate with other network elements, servers, platforms, or providers using a wired or wireless connection, and may utilize WiFi, 3G, 4G, LTE, Bluetooth, or other chipsets. Business 103 may provide voice, communication, data, Internet connectivity, television, media broadcast, video on demand, telephone, monitoring, security, troubleshooting, upgrade, repair, and/or warranty services, for example, to these various devices. Moreover, network element 115, tablet computer 120, network client 130, video display device 140, and/or mobile device 150 may represent a plurality of network elements, tablet computers, network clients, video display devices, or mobile devices, respectively, within an entity (including a household, business, and/or government agency), for which business 103 may provide such products and/or any related services.

The products mentioned above and their related services (if any) are exemplary only, and it should be appreciated that other products and/or services fall within the scope of the present invention. Other products may include health care devices such as blood pressure monitors or heart rate monitors, digital video recorders (DVRs), routers, modems, game consoles, cameras, security systems, automation systems, remote access systems, telematic systems, machinery, or vehicles, for example. Hereafter, these products and/or services will generally be referred to as “product/service 118.” Product/service 118 may be communicatively coupled directly with network 102 or via one or more intermediary devices, such as, but not limited to, transceiver 117 or network element 115. However, product/service 118 need not be coupled to network 102; rather, a customer from customer base 110 or a member of online community 170 may communicate or transmit data via network 102 with other network elements and such communications or data may relate to product/service 118.

Network 102, network element 115, and/or transceiver 117 may be used by business 103 to provide services to customer base 110 and/or exchange information within the crowd care system 100, including crowd care platform 101, employees 104, knowledge databases 105, customer base 110, and/or online community 170. Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support an Internet network, a wireless communication network, a cellular network, Bluetooth, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a government network, a cellular network, corporate networks, or home networks.

Data may be transmitted and received via network 102 utilizing a standard telecommunications protocol or a standard networking protocol. For example, one embodiment may utilize Session Initiation Protocol (“SIP”). In other embodiments, the data may be transmitted or received utilizing other Voice Over IP (“VoIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

Transceiver 117 may be a repeater, a microwave antenna, a cellular tower, or another network access device capable of providing connectivity between different network mediums. Transceiver 117 may be capable of sending or receiving signals via a mobile network, a paging network, a cellular network, a satellite network or a radio network. Transceiver 117 may provide connectivity to one or more wired networks and may be capable of receiving signals on one medium such as a wired network and transmitting the received signals on a second medium, such as a wireless network.

Network element 115 may be a set top box, digital video recorder (DVR), router, modem, customer premises equipment (CPE), a residential gateway, a server, a subscriber module, or an access point, for example. Network element 115 may be communicatively coupled with network 102 to thereby allow various devices to communicate with other network elements via network 102.

Information may be transmitted or communicated to crowd care platform 101 via network 102, transceiver 117, network element 115, “admin” portal 106, and/or crowd care portal 107. For example, customer base 110 and/or online community 170 may transmit information to or through crowd care platform 101 through the crowd care portal 107, and employees 104 may transmit information to or through crowd care platform 101 through the admin portal 106. The information may then be filtered and/or stored in knowledge database 105 for future use by business 103.

It should be appreciated that each of the communications devices, servers, modules, or network elements may include one or more processors. One or more data storage systems (e.g., databases) may also be coupled to each of the devices or servers of the system. It should also be appreciated that software may be implemented in one or more computer processors, modules, network components, services, devices, or other similar systems.

System 100 of FIG. 1 may be implemented in a variety of ways. Architecture within system 100 may be implemented as a hardware component (e.g., as a module) within a network element. It should also be appreciated that architecture within system 100 may be implemented in computer executable software (e.g., on a tangible, non-transitory computer-readable medium). Module functionality of architecture within system 100 may be located on a single device or distributed across a plurality of devices including one or more centralized servers and one or more mobile units or end user devices.

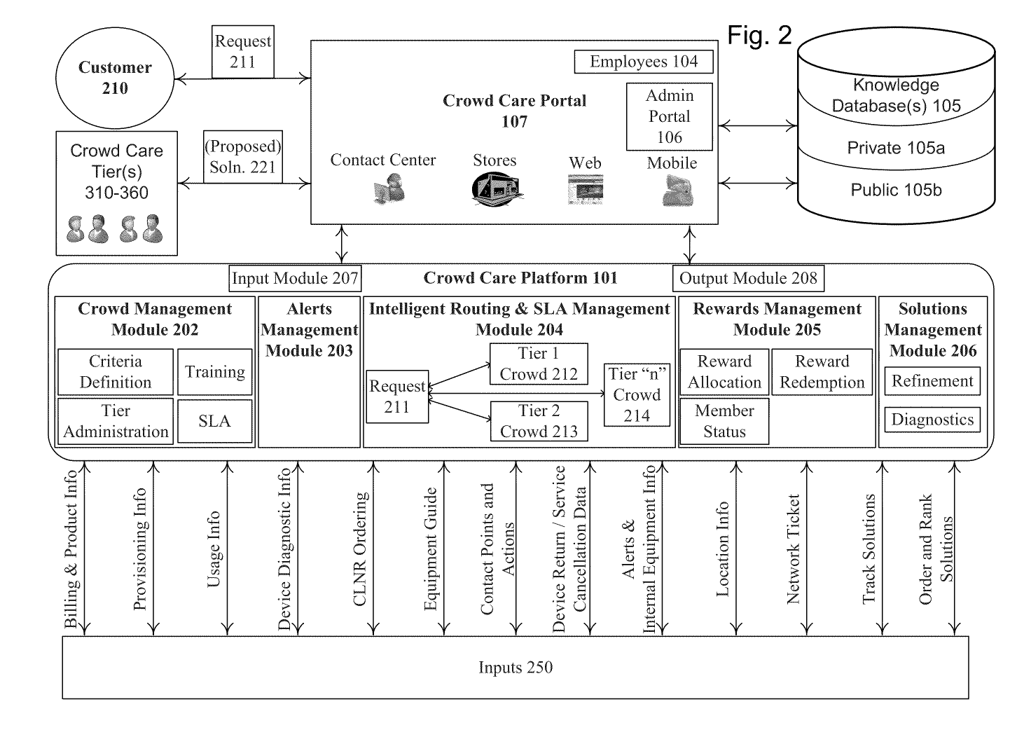

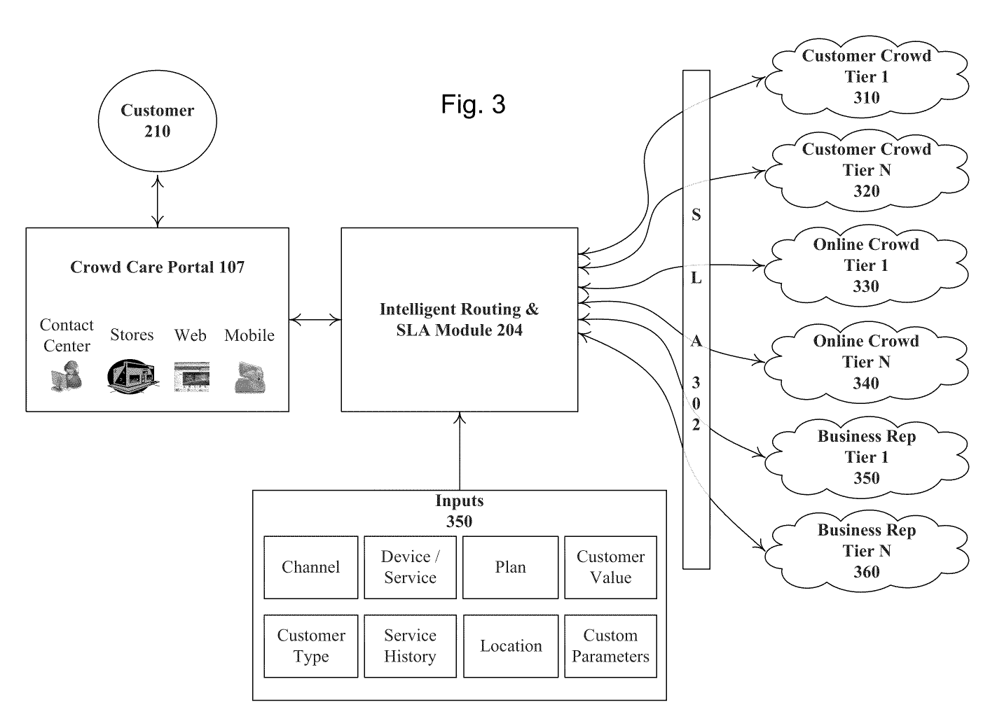

Referring to FIG. 2, a diagram of an exemplary crowd care platform 101 is shown, according to an exemplary embodiment. The crowd care platform 101 may be said to comprise the crowd care portal 107, admin portal 106, and knowledge database 105. The crowd care platform 101 may be accessed by employees 104, online community 170, customer base 110, and/or customer 210, for example. Customer 210 may be a member of customer base 110 from FIG. 1, and customer 210 may represent an individual or entity with an inquiry or “request” 211. As explained above, request 211 may represent a question, inquiry, issue, problem, complaint, suggestion, or a combination of these, for example, from customer 210. Customer 210 may also represent a prospective customer, for example, and customer 210 may not be a current member of customer base 110. Online community 170 may represent members from the general public, which members may have entered into an agreement with business 103 to provide services or information for the purpose of answering request 211 of customer 210. This agreement may be a service level agreement 302 (FIG. 3), and other crowd care providers and even customer 210 may also enter into a service level agreement 302 with business 103. Service level agreement 302 may vary with respect to customer 210 and the various crowd care providers, as explained further below.

Customer 210 may submit a request 211 to the crowd care platform 101 through various channels, including a contact center (e.g., by contacting a representative of business 103), by coming into a retail store of business 103, via the web, live chat, and/or via a computing device such as a mobile device 150, for example. Representative channels are shown in FIG. 2 under crowd care portal 107; however, there may be other channels by which customer 210 may submit a request 211 or otherwise exchange information with crowd care platform 101. Customer 210 may also have access to the public portion of knowledge database 105 (105b) via crowd care portal 107 and/or the Internet, for example. Customer 210 may refer to public knowledge database 105b in an attempt to answer their own request 211, before or after submitting the request 211 to crowd care platform 101. Customer 210 may also have access to at least a portion of the private knowledge database 105a, via crowd care portal 107 and/or Internet, for example. Access to the private knowledge database 105a may be governed by a service level agreement 302 with customer 210.

Members of customer base 110 who have agreed to be crowd care providers (i.e., the “customer crowd”) may also interact with crowd care platform 101 through each of these representative channels, though for the sake of explanation, the customer crowd will be considered to interact with crowd care platform 101 via the Internet. The customer crowd may have access to public knowledge database 105b via crowd care portal 107 and/or the Internet, for example, and may refer to such database in an attempt to answer request 211. The customer crowd may also have access to at least a portion of the private knowledge database 105a, via crowd care portal 107 and/or the Internet, for example. Access to the private knowledge database 105a may be governed by service level agreement 302 with the customer crowd.

Online community 170 may also interact with crowd care platform 101 through each of these representative channels, though for the sake of explanation, online community 170 will be considered to interact with crowd care platform 101 via the Internet. Online community 170 may have access to public knowledge database 105b via crowd care portal 107 and/or the Internet, for example, and may refer to such database in an attempt to answer request 211. Online community 170 may also have access to at least a portion of the private knowledge database 105a, via crowd care portal 107 and/or the Internet, for example. Access to the private knowledge database 105a may be governed by service level agreement 302 with online community 170.

Employees 104 may also interact with crowd care platform 101 through each of the channels discussed above, though for the sake of explanation, employees 104 will be considered to interact with crowd care platform 101 via the admin portal 106. Employees 104 may be considered to have full access to the private (105a) and public (105b) knowledge databases. Moreover, employees 104 may be responsible for updating, editing, refining, and/or auditing the private/public knowledge databases 105a/105b.

Crowd care platform 101 may comprise a number of modules to aid in answering/resolving request 211. For example, crowd care platform may comprise a crowd management module 202, an alerts management module 203, an intelligent routing and SLA management module 204, a rewards management module 205, a solutions management module 206, an input module 207, and an output module 208, for example. Each of these exemplary modules will be explained in turn below.

Crowd care platform 101 may receive various data via input module 207. Such inputted data may come from numerous sources, including those shown in FIG. 2, viz., customer 210, crowd care tiers 310-360, employees 104, private/public knowledge databases 105a/105b, any of the modules of crowd care platform 101, and the various inputs 250 listed below the crowd care platform 101 in FIG. 2, for example. This inputted data, and other data generated by or stored in the various modules of the crowd care platform 101, may be outputted by output module 208 to the entities/elements described above, including customer 210, crowd care tiers 310-360, employees 104, private/public knowledge databases 105a/105b, input sources 250, and/or to any of the modules of crowd care platform 101, for example.

Referring to inputs 250 in FIG. 2, the various elements listed above inputs 250 may be considered exemplary types of inputs 250. Inputs 250 may be considered to be data that is stored in one or more databases (not shown), or that is pulled from a related storage module (not shown), such as a customer or product database or a case management module, for example. Each of the inputs 250 may be used to find and ultimately provide a proper solution to request 211 of customer 210. Reference will now be made to the exemplary inputs 250 shown in FIG. 2.

Billing and product info may represent information regarding billing of customer 210 (such as billing cycle, minutes used, data allowance, for example) and the products or services associated with customer 210 (such as rate plan or available product/service features, for example). For example, if request 211 indicates that cellular data is not working on mobile device 150, then billing and product information may be retrieved from a relevant database to see if customer 210 previously purchased the data feature.

Provisioning info may represent information regarding which network elements (Home Location Register (HLR), Authentication, Authorization and Accounting (AAA), or IP Multimedia Subsystem (IMS Core), for example) are provisioned for the particular customer 210 submitting request 211. For example, if request 211 of customer 210 indicates that ringback tone is not working, then data from the relevant network elements that enable ringback tone may be retrieved to determine whether such network elements are setup properly. Ringback tone is a feature that enables the customer to select specific music to be played for the calling customer instead of the standard ringtone. For this feature to work, the customer's phone number needs to be setup correctly in a ringback tone server in the network. Accordingly, data from the ringback tone server and other network elements may be retrieved to determine whether the customer's phone number is correctly registered or whether the relevant network elements are setup properly.

Usage Info may represent call data, such as incoming and outgoing calls, incoming and outgoing text messages, and/or data sessions, for example. This usage info may be used for troubleshooting. For example, if request 211 of customer 210 suggests that customer 210 is having trouble with dropped calls, then the usage info (e.g., call data) may provide information about the location of customer 210 during such dropped calls and/or cell tower information. The usage information may aid in troubleshooting or responding to request 211.

Device Diagnostic Info may represent diagnostic information for the device or services that may be the subject of, or related to, request 211, such as mobile device 150. Exemplary device diagnostic info may include device type, device settings, device setup, memory utilization, battery utilization, and applications running on the device, for example.

CLNR Ordering may represent information used in a “certified like new replacement” (CLNR) process for ordering a replacement device, such as mobile device 150. For example, if request 211 pertains to a device issue, and a determination is made that the issue cannot be resolved, then a replacement device will be ordered and sent to customer 210.

Equipment Guide may represent guides, manuals, and/or details about product/service 118 and any associated rate plans, features, or devices, for example.

Contact Points and Actions may represent information from the various channels (web, computing device, retail store, contact center, for example) that the customer used to submit request 211 and any actions that occurred at that channel, such as bill payment, address change, or request to disconnect, for example. As an example, customer 210 may have entered a retail store and spoken with a representative of business 103 regarding an issue. Details of the issue may be recorded by the business representative and/or customer 210, which may be encapsulated in the form of a request 211. The business representative or others may have taken various actions with respect to the customer's issue. These actions may be recorded and provided as an input to the crowd care platform 101, along with who took the actions and the time and location of those actions. The recorded actions and/or details of the issue may be provided as an input to the crowd care platform 101 even if the customer's issue was resolved in the retail store, and such data may be recorded in knowledge database 105a/105b for the purpose of assisting others in resolving similar, future requests. Moreover, Contact Points and Actions information may be used for routing requests and/or for analytics purposes.

Device Return/Service Cancellation Data may represent information gathered from a product 118 returned from customer 210 or the reasons for cancellation of a service 118 by customer 210. If customer 210 is provided a replacement device, the customer 210 may be expected to return the original device that is being replaced. Business 103 may track these returns to make sure the damage description that customer 210 provided matches with the actual damage. Alternatively, customer 210 may be required to return a product upon cancellation of service 118. Business 103 may track these returns to make sure there is no damage to the product. This information may be used to provide any credit or charge to customer 210 appropriately, which may be considered part of resolving request 211. Moreover, the reasons for cancellation of a service 118 may be recorded and used by business 103 to improve provision of services to other customers.

Alerts & Internal Equipment Info may represent various alerts that help the crowd care provider in troubleshooting possible requests 211. Exemplary alerts include network alerts, which may indicate if there is any network outage. Such alerts may precede receipt by the crowd care platform 101 of requests 211 related to the subject of the alert, and thereby aid the crowd care provider in resolving the issue in the request 211. In an exemplary embodiment, the Alerts and Internal Equipment Info may only be accessible or provided to employees 104, such that this information is kept private from other crowd care providers including customer and/or online community crowd care providers. As explained in further detail below, the intelligent routing and SLA module 204 may take into account the private nature of various inputs 250, such as the Alerts and Internal Equipment Info. Accordingly, if analysis of request 211 by the crowd care platform 101 suggests that request 211 pertains to a private input 250 accessible only to employees 104, such as the Alerts and Internal Equipment Info according to an exemplary embodiment, then the routing module 204 may route request 211 directly to a business rep tier 350/360 without first (or in lieu of) routing to a customer crowd tier 310/320 or an online community tier 330/340. Other exemplary alerts may include, for example, software patches, updates, device manufacturer notices, or internal or external equipment alerts, which may provide information about known equipment issues. Alerts pertaining to “internal equipment,” i.e., equipment internal to business 103, may also be considered private and restricted to employees 104, according to an exemplary embodiment. However, other alerts such as software patch alerts, update alerts, device manufacturer notices, or external equipment alerts, for example, may be accessible to all or a subset of the crowd care providers that receive request 211 by routing module 204.

Location Info may represent information about a current or previous location of a device. This location may be represented by coordinates such as GPS coordinates, and may be stored over a period of time. In an exemplary embodiment, the Location Info is accessible only to employees 104 or the business rep tiers 350/360.

Network Ticket may represent information gathered during current or previous troubleshooting efforts by a representative associated with business 103 at the crowd care portal 107. A “ticket” may be considered synonymous to a request 211, except that a request 211 may be considered to be generated by customer 210 while a ticket may be considered to be generated by a representative of business 103. Nevertheless, for the sake of explanation, a ticket may be considered synonymous to request 211. A ticket may be opened whenever an issue needs troubleshooting and the ticket may include various data from either customer 211 or someone associated with business 103, such as employees 104, or representatives at a contact center or a retail store, as reflected in the crowd care portal 107 of FIG. 2. Additional data may be added to the ticket or request 211 by the customer crowd tier(s), online community tier(s), and/or business rep tier(s) during their efforts to resolve request 211. Tickets and requests 211 from previous troubleshooting efforts may be stored and catalogued by topic, product, service, and/or customer name/ID to aid in future troubleshooting or responding efforts. Tickets may be classified in order to be catalogued. Moreover, tickets, like requests 211, may be assigned to or associated with a particular division of business 103, a particular crowd care tier or a particular crowd care provider, based on the classification and the expertise of the person/tier to which the ticket is assigned. For example, if the problem is determined to be network related, then the ticket/request may be classified as a network problem and assigned to a tier/person with network expertise. Alternatively, if a particular crowd care provider previously worked on responding to request 211, then that particular crowd care provider may receive a future iteration of that request 211, such as a subsequent inquiry by the same customer 210 on the same topic.

Track Solutions may represent information gathered and refined over time with respect to solutions to request 211. For example, various solutions may be attempted in order to resolve request 211, but only one or a combination of two or more of the attempted solutions may end up being the correct solution(s). The attempted solutions and the ultimately correct solution(s) may be tracked so as to aid in resolving future requests 211 that may relate to an earlier request 211 of the same or a different customer. Requests 211 may relate to each other by being from the same customer 211 and/or having a similar issue within request 211.

Order and Rank Solutions may represent information on solutions or near-solutions to requests 211 that have been ordered and/or ranked by a crowd care provider or employees 104, for example. Request 211 may not encapsulate all the necessary information to immediately determine the correct solution. Accordingly, various solutions may need to be attempted in order to answer or resolve request 211. The attempted solutions may be ranked based on their outcome and relevance to request 211. Based on a ranking of previously attempted solutions for previous requests 211, an “order” of solutions may be generated that may be used to aid in resolving future requests 211 of the same or a different customer. Like the other inputs 250, this information may be stored in the private and/or public knowledge databases 105a/105b.

Referring again to the modules within the crowd care platform 101, the crowd management module 202 may be responsible for managing the “crowd,” i.e., individuals involved in resolving request 211, or updating knowledge database 105. As referred to above, the “crowd” may comprise different types of crowd care providers, such as customer base 110, online community 170, or business representatives such as employees 104. These groups of crowd care providers are referred to in FIG. 3 as the customer crowd tier 310/320, online community tier 330/340, and business rep tier 350/360, respectively. Each of these groups or tiers may have several subcategories or levels. For example, online community 170 may range from “beginner” to “expert,” or from “1” to “10” in terms of their proven expertise. Crowd management module 202 may be responsible for managing definitions of these categories and/or their related criteria. The Criteria Definition portion of crowd management module 202 may comprise a database that defines the pre-requisites for someone to become a crowd care provider within a crowd care tier. By way of example, online community 170 may represent individuals or entities that are not customers/clients of business 103, but have expressed an interest in participating in resolving requests 211 or in updating knowledge database 105 (or in other words, becoming a “crowd care provider”). This interest in becoming a crowd care provider may be expressed by entering a service level agreement with business 103. Alternatively, online community 170 may be current or former customers/clients of business 103, and in one exemplary embodiment, members of online community 170 may not be required to enter a service level agreement with business 103 in order to become a crowd care provider. Also by way of example, customer base 110 may represent individuals or entities that are current or former customers of business 103 in that they have a product/service 118 provided by business 103. Customer base 110 may comprise individuals that have expressed an interest in becoming a crowd care provider. This interest in becoming a crowd care provider may be expressed by entering a service level agreement with business 103. Crowd care providers may have a customer or crowd care provider ID that was provided to them by business 103. Crowd care providers may also have a userID that they provided to business 103. Crowd care provider IDs and userIDs may be stored in the crowd management module 202 along with corresponding data for each crowd care provider.

The training portion of crowd management module 202 may provide training opportunities for the crowd care providers. For example, various training courses may be provided to the crowd care providers to allow them to achieve a new level within their respective category or tier. For example, a member of online community 170 or customer base 110 may take online “courses” and/or “tests” via network 102, administered by crowd management module 202, in order to move from a level “1” to a level “10” of their respective category or tier. Higher levels may be associated with increased opportunities for crowd care provider participation, and/or increased rewards or opportunities for rewards.

The tier administration portion of crowd management module 202 may handle registration of new crowd care providers and may administer which tier the crowd care providers belong to. The tier administration portion may provide a registration form via the crowd care portal 107 to, for example, a member of online community 170 or customer base 110. Registration may entail providing individual information, choosing a userID and password, and entering a service level agreement 302 with business 103. Upon registering, the crowd care provider's information may be retained and updated in the tier administration portion of crowd management module 202. By way of example, a registered crowd care provider of online community 170 may move from a level 1 to a level 5 of the online community 170 tier by taking various courses or passing various tests administered by the training portion of crowd management module 202. Similar opportunities for advancement may be provided to customer base 110 that have registered to become crowd care providers. A particular crowd care provider's level may be recorded in the tier administration portion, and referred to by the crowd management module 202 for administering the proper courses and/or tests in the future, for example. Data in the tier administration portion may be accessed by any other module of crowd care platform 101, such as, for example, rewards management module 205 for the purpose of rewarding appropriate awards or incentives to the crowd care provider.

Alerts management module 203 may work in conjunction with output module 208 to send any alerts to the crowd care providers or customer 210. The alerts may convey many types of information and may relate to request 211, any portion of crowd care platform 101, crowd care portal 107, or knowledge database 105. For example, an alert may be related to a response to request 211, a service level agreement, or a routing decision of request 211 by the intelligent routing and SLA management module 204. An alert may also relate to training opportunities, test results, and/or tier administration by the crowd management module 202. An alert may also relate to member status, or an allocation or redemption of a reward, by rewards management module 205. An alert may also relate to proffered solutions by a crowd care provider, or how such proffered solutions are handled, by, for example, the solutions management module 206. Alerts may be conveyed via network 102 and may comprise an email, a text message, a phone call, a social media message, an on-screen overlay or pop-up, or any other method of conveying information. Alerts may be delivered according to a preferred means of communication of the customer 210 or crowd care provider. For example, customer 210 may prefer that all alerts regarding request 211 be delivered by email because the request 211 pertains to network access by customer 210's mobile device 150. The preferred means of communication may be received upon receipt of request 211, or upon registration of a crowd care provider, and may be stored in the crowd management module 202.

Rewards management module 205 may manage reward allocation to a crowd care provider and/or reward redemption by a crowd care provider. Rewards may be in the form of points, which may be redeemed for a variety of tangible or intangible items, and which may or may not have monetary value. For example, points may be redeemed for discounts, upgrades, gift certificates, awards, prizes, miles, subscriptions, cash, or various products or services. Business 103 may offer these exemplary items with respect to products or services provided by business 103, or it may contract with other businesses for the purpose of offering these items for reward redemption. Discounts may relate to discounts on services offered by business 103. For example, a mobile device customer from customer base 110 may be rewarded for his/her participation as a crowd care provider, and may be cumulatively awarded 1,000 points based upon the quantity and/or quality of such participation, and these points may be redeemed for a discount on the customer's monthly or annual cellular service (such as a 10-100% discount, for example), a free or discounted upgrade to a new mobile device, or a discount on service for a new device, such as a tablet or a new phone line. Reward points may also be a reflection of the status of the crowd care provider. For example, a crowd care provider that has accumulated 30,000 points (regardless of whether such points have been redeemed) may be considered to have a higher “status” relative to other crowd care providers because of the amount of points this member has accumulated. Accordingly, in addition to a tier “level” as discussed above, a member may have a points “status” based on the number of points the member has accumulated, which in turn is based on the amount and quality of participation of this member in the crowd care system.

A crowd care provider's “level” may relate to expertise, and may dictate what types of requests 211 the crowd care provider receives or is requested to handle. For example, a crowd care provider having a level of “8” may receive requests 211 that are more complex to resolve, such as connectivity issues away from a home/business network. A crowd care provider having a level of “2” may receive requests 211 that are less complex, such as issues with respect to particular applications on a mobile device. The complexity of a particular request 211 may be analyzed by the intelligent routing and SLA management module 204 by analyzing the text within request 211 and comparing the text to historical issues from previous requests, and/or by comparing the text to information in the knowledge database 105, such as a keyword index.

A crowd care provider's “status,” which may relate to the number of points the provider has accumulated as discussed above, may entitle the provider to increased opportunities for participation in the crowd care system. This is based on the assumption that crowd care providers who have accumulated more points have a greater willingness to participate, and hence may respond more quickly and/or with greater expertise relative to other crowd care providers of a lower “status.”

Solutions management module 206 may manage which solutions are ultimately selected as being the correct solution(s) for resolving request 211. A number of proposed solutions may be received via crowd care portal 107 from various crowd care providers in response to request 211 from customer 210. The proposed solutions may be repetitious, relevant, irrelevant, correct, incorrect, or partially correct, with respect to request 211. Solutions management module 206 may be configured to make an initial determination as to relevancy of the proposed solution by, for example, analyzing the text of the proposed solution and comparing to the text of request 211 to information in knowledge database 105. Keywords or phrases from request 211 may be compared to a keyword index in the private 105a and/or public 105b knowledge databases to reveal various related help topics. Exemplary keywords or phrases may include “connect,” “dropped call,” “network outage,” “data,” “download speed,” “battery,” “broken,” “backup,” “bill,” “upgrade,” or “unlock,” for example. Keywords and/or phrases may be included in a keyword index in the public/private knowledge database 105a/105b. After this exemplary keyword/phrase analysis, proposed solutions received via crowd care portal 107 may be designated as relevant or irrelevant to the particular request 211 by the solutions management module 206. Proposed solutions designated as irrelevant may then be discarded or may receive a cursory review from another crowd care provider (such as employee 104 or another crowd care provider having a higher level than the crowd care provider who submitted the proposed solution, for example) to confirm that it is irrelevant, and if irrelevant, may be discarded. Proposed solutions designated as relevant by the solutions management module 206 may receive additional review from another crowd care provider (such as employee 104 or another crowd care provider having a higher level than the crowd care provider who submitted the proposed solution, for example) to determine whether the proposed solution is correct, incorrect, or partially correct. Partially correct proposed solutions may be combined with other partially correct proposed solutions, or other input by another crowd care provider, to yield a completely correct solution to request 211. Alternatively, a “completely” correct solution to request 211 may not result until additional information is gathered from customer 210. Nevertheless, after proposed solutions and/or other input are combined to yield a correct solution, or after receipt of a single correct solution, the solution may be output to customer 210 via alerts management module 203 as a single “proposed solution.”

In an alternative embodiment, a plurality or all of the proposed solutions may be submitted to customer 210 via alerts management module 203, and customer 210 may be responsible for choosing which proposed solution correctly resolves request 211. This submission of the proposed solutions to customer 210 may occur before or after solutions management module 206 determines relevancy of the proposed solution to request 211. If after, only the relevant proposed solutions would be submitted to customer 210 in a preferred embodiment.

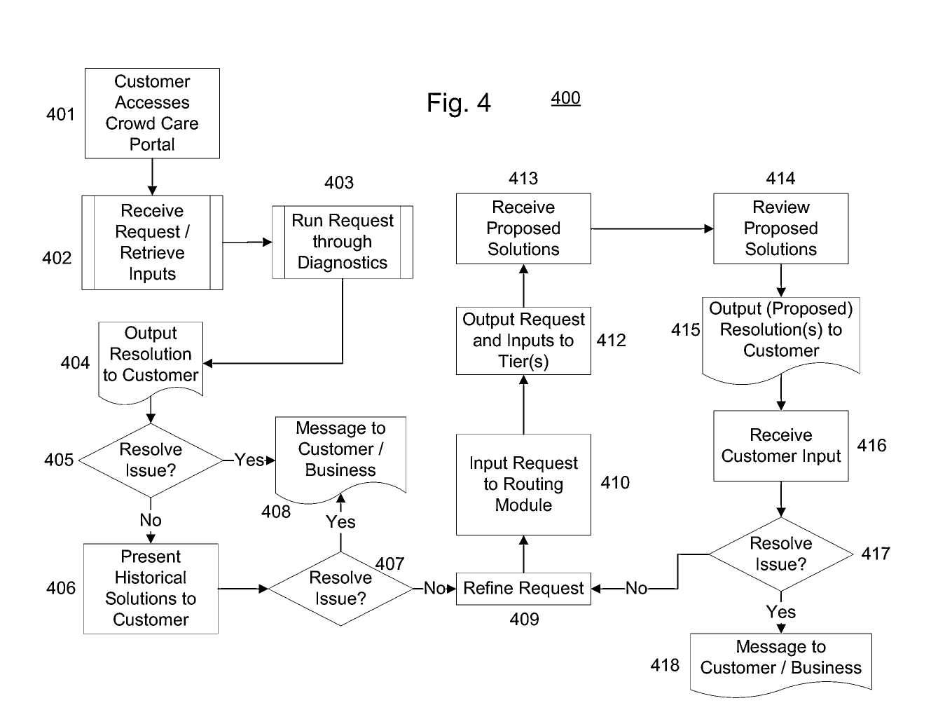

Regardless of whether customer 210 or employee 104 determines which solution correctly resolves request 211, such solutions (and/or the problems initially defined in request 211) may be further refined by modifying the language of the solutions/problems, linking to other solutions, elaborating on, and/or further defining the solution or the nature of the problem (as initially defined in request 211). Such refinement may occur at a refinement portion of the solutions management module 206, and may occur while a particular request 211 is being resolved (as explained below with regard to FIG. 4), or outside of the process of resolving a particular request, in the form of a “solution audit” during which solutions recorded in database 105 may be audited to confirm that such solutions meet standards defined by business 103. The refined solutions/problems may be stored in private/public knowledge database 105a/105b to aid in resolving future problems or requests. In this manner, the language in the knowledge database 105 may be approved by business 103 and various “lessons learned” may be stored for future use.

The intelligent routing & SLA module 204 (i.e., routing module 204) will be explained in further detail by referring to FIG. 3. FIG. 3 depicts an exemplary process flow for submitting a request 211, routing the request 211 to one or more tiers, receiving a (proposed) solution 221 to request 211 from the one or more tiers, and then sending the (proposed) solution 221 to customer 210. Various tiers are shown in FIG. 3 and these tiers represent the various customer care providers, according to an exemplary embodiment of the invention. Customer crowd tier 1 310 to customer crowd tier “n” 320 represent a plurality of customer crowd tiers, and such tiers may comprise customers from customer base 110 who have agreed to be crowd care providers and who have agreed to a service level agreement 302. Customer crowd tier 1 320 may represent customer crowd care providers with lower expertise or a beginning level of experience as a crowd care provider, each of which may be defined by the tier administration portion of crowd management module 202. This lower tier may not have received any training, passed any tests administered by the training portion of crowd management module 202, or participated in previous crowd care tasks (e.g., responding to requests 211), and accordingly may be represented as having a beginning level of expertise (e.g., level “1”). Customer crowd tier “n” 330 may represent successively higher levels of expertise or experience among the customer crowd care providers, as defined by the tier administration portion of crowd management module 202. Individuals in these successively higher tiers may have received training, passed tests administered by the training portion of crowd management module 202, or participated in a number of crowd care tasks, and accordingly may be represented as having a higher level of expertise (e.g., levels “2”-“10”).

Online crowd tier 1 330 and online crowd tier “n” 340 may comprise members from online community 170 who have agreed to be crowd care providers and have agreed to a service level agreement 302. Similar to above, online crowd tier 1 330 may represent online community crowd care providers with lower expertise or experience and online crowd tier “n” may represent online community crowd care providers with a higher level of expertise or experience, as defined by the tier administration portion of crowd management module 202. Similar to customer crowd care providers, online community crowd care providers may receive training, take tests administered by the training portion of crowd management module 202, and/or participate in a number of crowd care tasks to achieve a higher level tier designation.

Business rep tier 1 350 and business rep tier “n” 360 may represent representatives of business 130, such as employees 104, who are participating as crowd care providers, and who may also have agreed to a service level agreement 302 or an employment agreement which may have similar terms to the service level agreement 302. Similar to above, business rep tier 1 350 may represent employees 104 with lower expertise or experience and business rep tier “n” may represent business employees 104 with a higher level of expertise or experience, as defined by the tier administration portion of crowd management module 202. Similar to customer and online community crowd care providers, business rep crowd care providers may receive training, take tests administered by the training portion of crowd management module 202, and/or participate in a number of crowd care tasks to achieve a higher level tier designation.

SLA 302 may represent one or more service level agreements between business 103 and the various tiers of crowd care providers, customer 210, and/or customer base 110. A core component of the service level agreement 302 includes time constraints, which may represent the period of time a crowd care provider has to respond to request 211 upon receipt of request 211 (or assignment of request 211 by routing module 204) if the crowd care provider is to receive credit (e.g., points) for responding. Such time constraints effectively allow business 103 to inform customer 210 when a response (such as a proposed solution 221) may be sent to customer 210. The time constraint portion of SLA 302 may differ or be the same with respect to each tier of crowd care providers or with regard to the status of a particular customer 210. For example, the time constraint in SLA 302 with respect to customer crowd tier 1 and tier “n” may be 30 minutes, such that customer crowd care providers have 30 minutes to submit a response to request 211. A time constraint period of 30 minutes is exemplary only, and the time constraint period may be shorter or longer with respect to each tier of crowd care providers. The response, which may be defined in the SLA 302, by the crowd care provider may be in the form of a proposed solution 221. If the customer crowd care providers 310/320 do not respond within their respective time constraint period, then the next or a different tier may be invited to respond to request 211 (i.e., routing module 204 may route request 211 to other tier(s)). Customer crowd care providers 310/320 may or may not be permitted to respond after their respective time constraint period has expired. If they are still permitted to respond after expiration of the time constraint period, the delinquent response may be awarded fewer points than would otherwise be the case, such as in the event that such response ends up being a correct response/solution to request 211.

In an exemplary embodiment, the one or more customer crowd care providers may be invited to respond to request 211 during a first time constraint period, and upon expiration of the first time constraint period, one or more online crowd care providers may be invited to respond to request 211 during a second time constraint period, and upon expiration of the second time constraint period, one or more business rep crowd care providers may be invited to respond to request 211. In alternative embodiments, online crowd care providers 330/340 may be invited to respond before customer crowd care providers 310/320, and business rep crowd care providers 350/360 may be invited to respond before customer and/or online crowd care providers. Alternatively, one or more tiers may be invited to respond at the same time for the duration of one or more time constraint periods, as defined in each tier's respective SLA 302.

Whether all tiers are invited to respond, the order with which the tiers are invited to respond, or the time during which the tiers are permitted to respond, may depend on the status of customer 210. For example, if customer 210 is an important customer to business 103, then business rep tier 350/360 may be invited to respond to request 211 before, at the same time, or in lieu of, other crowd care provider tier(s) to provide a quick response to request 211 by those having high expertise (e.g., employees 104). Alternatively, all crowd care provider tiers may be invited to respond to request 211 at the same time if request 211 was submitted by an important customer, such that request 211 may receive a more immediate response due to the large number of crowd care providers invited to respond. Alternatively, the crowd care tier(s) invited to respond may have less time to respond based upon the higher status of customer 210. The status of customer 210 may be received as an input 350 into the routing module 204 upon or after receipt of request 211 from customer 210. Inputs 350 shown in FIG. 3 may correspond to, be the same as, or additional to the inputs 250 described with respect to FIG. 2. Each of inputs 250/350 may be retrieved by the routing module 104, and conveyed to one or more crowd care tiers along with request 211.

Inputs 350 may represent data input from databases internal to business 103, inputs directly from customer 210 such as from customer 210's device, inputs from a crowd care provider, or inputs from knowledge database 105, for example. By way of example, “channel” may represent the method by which customer 210 submitted request 210; e.g., contact center, retail store, web, or mobile device. The channel used to submit request 210 may be attached to request 210 as additional data, and may be monitored by business 103 to provide better customer care.

“Customer Type” may represent the customer designation, such as individual, business, or government. Customer type may also include the size of customer 210.

“Device/Service” may represent the product or service that is the subject of request 211. This may be automatically determined by the routing module 204, and/or solutions management module 206, by analyzing the content of request 211 and/or by reading metadata associated with request 211, which may include a device ID. Details of the device/service may be input directly by customer 210 into the crowd care portal 107, or retrieved by the routing module 204 using a customer ID associated with customer 210, for example. Upon receiving a customer ID at crowd care portal 107 from customer 210, details of the devices and/or services associated with customer 210 may be retrieved by the routing module, and such information may be conveyed to one or more tier(s) along with request 211.

“Service history” may represent previous services provided to customer 210, and may or may not relate to troubleshooting efforts with respect to product/service 118 associated with customer 210.

“Plan” may represent the particular service plan to which customer 210 is currently or was previously subscribed. The service plan may or may not be associated with a product provided by business 103.

“Location” may represent a location of customer 210 or location data of a device associated with customer 210. Location may be in the form of coordinates, zip code, city/state, or street address, for example. Such data may be informative of the services or products which are available to customer 210, and/or may provide clues as to how to resolve a problem identified in request 211.

“Customer value” may represent an internal ranking of customer 210, and such internal ranking may indicate the importance of customer 210 to business 103. Customer value may be based on the amount of revenue attributable to customer 210, the amount or type of products/services purchased by customer 210, the length of time customer 210 has been a customer of business 103, and/or the number or subject matter of requests 211 previously submitted by customer 210, for example.

“Custom parameters” may represent other parameters defined by business 103 and may include outputs from other modules shown in FIG. 2, such as crowd management module 202. For example, custom parameters may include definition(s) of the SLA 302 or definitions of the crowd care tiers. As explained above, each of inputs 250/350 may be retrieved by the routing module 104, and conveyed to one or more crowd care tiers along with request 211.

As shown in FIG. 3, data may be exchanged between crowd care portal 107, routing module 204, and tiers 310-360. Data exchanged between tiers 310-360 and routing module 204 is represented in FIG. 3 as going through SLA 302 to highlight the embodiment of the invention where the SLA governs participation of the crowd care providers in the crowd care system. For example, routing module 204 may route request 211 and any other relevant data (such as one or more inputs 250/350) to customer crowd tier 1 310. Then customer crowd tier 1 310 may have 30 minutes, for example, to respond to request 211, as contained in an exemplary SLA 302 for customer crowd tier 1. Responses from customer crowd tier 1 310 may be reviewed by employees 104 and/or another crowd care provider having a higher level than customer crowd tier 1 (such as one of the business rep tiers 350/360), and either approved for sending to customer 210 or denied. In one exemplary embodiment, if customer crowd tier 1 310 does not submit an approvable response (e.g., a response that is approved by employees 104/business rep tier 350/360) within the relevant time constraint period, then request 211 may be routed to a crowd care tier having more expertise, such as online crowd tier 1 330, for review and response. Then, online crowd tier 1 may have 45 minutes, for example, to respond to request 211, as contained in an exemplary SLA 302 for online crowd tier 1. Online crowd tier 1 may have a longer time constraint period than customer crowd tier(s) due to the more limited number of individuals in the online crowd tier(s). Alternatively, online crowd tier 1 may have a shorter time constraint period than customer crowd tier(s) due to the additional expertise of individuals in the online crowd tier(s) and the correspondingly less amount of time needed to respond to request 211. If online crowd tier 1 330 does not submit an approvable response (e.g., a response that is approved by employees 104/business rep tier 350/360) within the relevant time constraint period, then request 211 may be routed to business rep tier 1 350 for review and response. As such, request 211 may be sent to successively higher level tiers, which may have increased expertise or experience, as defined by the tier management portion of the crowd management module 202. In this manner, opportunities for responding to various customer requests 211 may be provided to members of customer base 110, which are in the customer crowd tiers, and/or to members of the online community tiers. Allowing customer crowd tiers and online crowd tiers to respond to customer requests 211 may reduce the number of inquiries to employees 104 of business 103, such as those within business rep tiers 350-360. In other words, a call-in-rate to business 103 for assistance with various requests 211 may be reduced. Moreover, request 211 may still be responded to in a short period of time (or in a relatively shorter period of time) due to the time constraint periods specified in each tier's SLA 302. Therefore, customer satisfaction may remain at least as high as in conventional situations where employees 104 respond to each request 211.

Referring to FIG. 4, an illustrative flowchart of a method for receiving and resolving a request 211 from customer 210 is shown. This exemplary method 400 is provided by way of example, as there are a variety of ways to carry out methods according to the present disclosure. The method 400 shown in FIG. 4 can be executed or otherwise performed by one or a combination of various systems and modules. The method 400 described below may be carried out by system 100 shown in FIG. 1 and the modules shown in FIG. 2, by way of example, and various elements of the system 100 and modules of FIG. 2 are referenced in explaining the exemplary method of FIG. 4. Each block shown in FIG. 4 represents one or more processes, decisions, methods or subroutines carried out in exemplary method 400, and these processes, decisions, methods or subroutines are not necessarily carried out in the specific order outlined in FIG. 4, nor is each of them required. Referring to FIG. 4, exemplary method 400 may begin at block 401.

At 401, customer 210 may access crowd care portal 107. This may occur, for example, by visiting a retail store of business 103 (or a third party store that is associated with business 103), calling a contact center of business 103, visiting a webpage of business 103, entering a chat session with a representative of business 103, or using an application (such as an app provided by business 103 or a messaging app) on a computing device, such as the customer's smartphone. For the sake of explanation, reference will be made to the customer 210 submitting and receiving information via an application on the customer's smartphone, but it should be appreciated that information may be exchanged between customer 210 and business 103 in any number of ways, including via the Internet, via a webpage, or more generally via network 102, as discussed in detail above. Customer 210 may enter information into the application (e.g., by filling out a form presented within the application) and may select various topics for the request/issue using drop down menus or radio buttons, for example. All such information from customer 210 may comprise request 211. Customer 210 may then submit request 211 to the crowd care platform 101 via the application.

At 402, crowd care platform may receive request 211. Request 211 may be assigned a unique number, such as a ticket ID, by solutions management module 206. Also at 402, the intelligent routing and SLA management module 204 may analyze request 211 by, for example, comparing text within request 211 to keywords within knowledge database 105, thereby locating keywords within request 211. Based on this analysis, routing module 204 may classify request 211 as pertaining to one or more particular topics and having a particular level of complexity or difficulty. Also at 402, routing module 204 may receive various inputs 350 and combine these inputs to request 211, such as in the form of a table appended to request 211. Information from inputs 350 and/or from within request 211 may cause the process to skip to 410, i.e., inputting the request 211 into routing module 204. This may occur, for example, if a diagnostic test cannot be performed (e.g., request 211 relates to a product/service 118 that is not accessible or a diagnostic test is otherwise irrelevant to request 211), if there are no historical solutions to present to customer 210, and/or to limit the amount of back-and-forth between customer 210 and the crowd care platform 101. Also, the “customer value” from input 350 may indicate that customer 210 is a high-value customer, so request 211 may be accelerated to routing module 410 so as to reduce the amount of time before a crowd care provider actually analyzes request 211 and submits (proposed) solutions.

At 403, solutions management module 206 may cause the application on the customer's smartphone to perform a diagnostic test, if applicable. The application may include a diagnostic testing capability, or may allow business 103 to connect to the customer's device to retrieve information that will aid in troubleshooting device problems. The output of diagnostic test may be used by the system 100 to provide one or more appropriate solution options to the customer.

The diagnostic test may reveal, for example, that customer 210 needs to upgrade their software to resolve request 211. At 404, a resolution to request 211 may be output to customer 210 based on results of the diagnostic test. The resolution(s) to request 211 may be in the form of information imparted to customer 210, a link to a webpage with more information, or a file, for example. The file may be in the form of a software update, for example. At 405, the application may ask customer 210 whether the results of the diagnostic test are/were sufficient to resolve request 211 and/or whether the received resolution has resolved request 211. If customer 210 indicates that the results of the diagnostic test, or the received resolution, are sufficient to resolve request 211, then the process may proceed to 408.

At 408, alerts management module 203 may request additional information on which particular diagnostic test result, or which particular received resolution, resolved request 211, and a customer response may be received. Also at 408, a message may be sent to business 103 indicating that request 211 has been resolved, and may also indicate which particular diagnostic test result or received resolution resolved request 211.

If the diagnostic test at 403 was unable to provide a resolution to request 211, or if customer 210 indicates that the resolution received at 405 did not resolve request 211, then the alerts management module 203 may output to customer 210 via a message or within the application, for example, one or more historical solutions to request 211, based upon the analysis performed by the intelligent routing and SLA management module 204. Historical solutions to previous requests may be stored in knowledge database 105, and by comparing the text of request 211 to keywords (such as a keyword index) in knowledge database 105, a subset of the stored historical solutions may be automatically retrieved from knowledge database 105 and presented to customer 210 at 406.

At 407, alerts management module 203 may ask customer, via a message with yes/no voting buttons or within an application on the customer's device, for example, whether the historical solutions presented to the customer at 406 have resolved request 211. If an affirmative response is received, then at 408, alerts management module 203 may request additional information on which particular historical solution resolved request 211, and a customer response may be received. Also at 408, a message may be sent to business 103 indicating that request 211 has been resolved, and may also indicate which particular historical request(s) resolved request 211. Solutions management module 206 may use this information to update knowledge database 105 by, for example, giving the particular historical solution stored within knowledge database 105 a greater relevance score as related to the keywords located within request 211.

If the historical solutions presented at 406 do not resolve request 211, or if there are no historical solutions to present to customer at 406, then the method may proceed to 409. At 409, request 211 may be refined by the solutions management module 206. Refining request 211 may comprise removing personal identification information of customer 210 from request 211, such as name, mailing address, email address, telephone number, or account number, for example. Refining request 211 may also comprise removing duplicative information, adding test results from a diagnostic test (such as the diagnostic test which may have been performed at 403), adding the historical solutions which may have been presented to customer at 406, and/or adding customer responses which may have been received at 404 and/or 407.

At 410, request 211 (which may be in the form of a “refined request” based on the actions taken at 409) is input into the intelligent routing and SLA management module 204. Routing module 204 may again analyze request 211 (or the refined request) by, for example, analyzing text within request 211, test results from the diagnostic test which may have been performed at 403, and the historical solutions which may have been presented to the customer at 406, and/or customer responses which may have been received at 404 and/or 407. The analysis may comprise comparing this information to keywords within knowledge database 105, to locate (updated) keywords within request 211 (based on the refined request), and/or comparing this information to criteria definitions for each tier and the levels within each tier, which definitions may be stored within the crowd management module 202. The analysis may also take into account the “status” of customer 210, as explained above, and/or the status of individuals within the various crowd care tiers, such that individuals with a higher “status” may receive priority over other individuals with respect to routing of requests 211.

Based on the analysis performed at 410, request 211 may be input to at least one crowd care tier, such as customer crowd tier 310/320, online crowd tier 330/340, and/or business rep tier 350/360. Each crowd care tier may be governed by its respective SLA 302, as discussed above. For example, request 211 may be routed to successively higher tiers based on the responses and/or lack of responses received from the lower tiers. Request 211 may be routed to one or more customer crowd tiers, and upon expiration of their respective time constraint period, request 211 may be routed to other crowd care tiers, such as one or more online crowd tiers and/or one or more business rep tiers, as explained above.

At 413, proposed solutions 221 to request 211 may be received from the crowd care tier(s). Proposed solutions 221 may be received during a time window which may relate to the time constraint periods for the respective tiers. The time window during which proposed solutions 221 may be received may be equal to or greater than the time constraint periods for one or a combination of the crowd care tiers. For example, if request 211 is successively routed from customer crowd tier 1 to online crowd tier 1, to business rep tier 1, the time window may be equal to the sum of the time constraint periods for, customer crowd tier 1, online crowd tier 1, and business rep tier 1. In this manner, proposed solutions 221 may be received from customer crowd tier(s) and/or online crowd tier(s) during the time window even though their respective time constraint periods have expired.

At 414, a member of the business rep tier(s), such as one of employees 104, may review proposed solutions 221 received from the crowd care tiers. Irrelevant proposed solutions 221 may be discarded and a plurality of proposed solutions 221 may be combined to yield fewer proposed solutions 221.

At 415, the proposed solutions 221 may be output to customer 210 by alerts management module 203. A request for information may accompany the proposed solutions 221 output to customer 210, such as asking whether the one or more proposed solutions 221 effectively resolved request 211. A message with voting buttons (such as yes/no) may be transmitted to customer 210 by alerts management module 203.

At 416, additional information may be received from customer 210, such as information relating to whether the proposed solutions 221 resolved request 211. Alternatively, if the proposed solutions 221 did not resolve request 211, customer 210 may provide additional details on request 211, including information not originally submitted but which could have been submitted at step 401, information on which proposed solutions 221 the customer tried, and information gleaned by the customer from attempting the proposed solutions 221.

At 417, based on the information received from customer 210, solutions management module 206 may determine whether request 211 has been resolved. If no, then the process may return to step 409 and request 211 may be refined or updated based on information received from customer 210 at step 416. Request 211 may also be updated with the history of request 211, including which potential solutions 221 were sent to customer 210, which crowd care provider provided those potential solutions 221, and why those proposed solutions 221 were not successful in resolving request 211, based on input from customer 210 at step 416. Routing module 204 may use this information to route the updated request to the same crowd care providers that previously received request 211. Alternatively, the updated request may be routed to crowd care providers having greater expertise or experience, such as a business rep tier. The crowd care providers that previously provided proposed solutions to request 211 may also be updated with information on the outcome of those proposed solutions 221 or the solution that ultimately resolved request 211.

If request 211 has been resolved, as determined based on information received from customer 210 at 416, then at 418, a customer message may be transmitted to customer 210 by alerts management module 203, such as a customer service-type message thanking the customer 210 for using the crowd care service provider. At 418, a business message may also be transmitted to business 103, such as to employees 104, solutions management module 206, and/or rewards management module 205, for example. Employees 104 and/or solutions management module 206 may use this business message to update knowledge database 105, by, for example, recording the potential solution(s) that effectively resolved request 211 and/or giving the particular solution(s) stored (or newly recorded) within knowledge database 105 a greater or lesser relevance score based on which potential solution(s) 221 did or did not ultimately resolve request 211, respectively. The business message may also include information on which particular individual(s) submitted the potential solution(s) 221 that ultimately resolved request 211. The rewards management module 205 may use this information to award points to the particular crowd care provider(s) based on the successful solutions.

Rewards management module 205 may also be configured to analyze relationships between requestors/customer 210 and responders/crowd care providers and/or the frequency of requests by particular customers and responses by particular crowd care providers to those particular customers, to prevent fraudulent ‘gaming’ of the system. For example, a customer 210 may conspire with friends who are part of a given tier such that after the system forwards the request for assistance to members of the tier, the co-conspirators immediately respond with an answer that they know will resolve customer 210's request 211. The rewards management module 205 may evaluate information from the requestor's device and the responders' device, such as location, IP address, or telephone number, for example, and may determine whether such devices often communicate with one another, such as in voice calls, e-mails, text messaging, or chat sessions. The rewards management module 205 may also analyze whether the requestor and the responder are associated with a single customer account or a single household or address. If the system determines that such relationships exist, the rewards management module 205 may block rewards or decline to increment rewards to the responding co-conspirator(s) accounts, or may prevent the particular crowd care provider(s) or customer(s) from participating in the crowd care system.

With the various embodiments described above, a customer request 210 may be resolved quickly and with less reliance on employees 104 of business 103. With the above-described embodiments, business 103 may ensure that customer requests 210 are resolved efficiently and correctly, while at the same time building a knowledge database 105 that may be used to resolve future customer requests 210 even more efficiently.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. A method comprising:
receiving a request, via a crowd care portal, from a customer of a business;
routing, by a routing module, the request to at least one crowd care tier of a plurality of crowd care tiers, the plurality of crowd care tiers comprising individuals who have entered a service level agreement with the business, the service level agreement comprising a time constraint period defining a period of time the individuals have to submit a solution to the request;
receiving, by the routing module, the solution to the request from the at least one crowd care tier, in compliance with the service level agreement; and
sending, by an alerts management module, the solution to the customer.

2. The method of claim 1, wherein the request pertains to a troubleshooting issue for a product or service sold by the business to the customer.

3. The method of claim 1, wherein the plurality of crowd care tiers comprise:
a customer crowd tier consisting of customers of the business;
an online community crowd tier comprising individuals who are not customers of the business; and
a business representative tier consisting of employees of the business.

4. The method of claim 1, further comprising receiving informational inputs at the routing module, and appending the informational inputs to the request before routing the request to the at least one crowd care tier.

5. The method of claim 1, further comprising receiving information from the customer about whether the solution sent to the customer resolved the request.

6. The method of claim 5, further comprising:
updating a knowledge database with the information received from the customer and the solution to the request received from the at least one crowd care tier; and
using the knowledge database to aid in resolving future requests from other customers.

7. The method of claim 1, further comprising rewarding individuals in the at least one crowd care tier who submit solutions to the request, with points that may be redeemed for discounts on products or services offered by the business.

8. The method of claim 1, further comprising defining, by a crowd management module, a level of expertise and/or experience required for membership in each of the plurality of crowd care tiers.

9. The method of claim 8, further comprising providing, by the crowd management module, training and/or testing opportunities to advance from one crowd care tier requiring a first level of expertise to a second crowd care tier requiring a second level of expertise greater than the first level of expertise.

10. The method of claim 1, further comprising refining, by a solutions management module, the request before routing the request to the at least one crowd care tier.

11. A system comprising:
a processor; and
a memory comprising computer-readable instructions which when executed by the processor cause the processor to perform the steps comprising:
receiving a request from a customer of a business;
routing the request to at least one crowd care tier of a plurality of crowd care tiers, the plurality of crowd care tiers comprising individuals who have entered a service level agreement with the business, the service level agreement comprising a time constraint period defining a period of time the individuals have to submit a solution to the request;
receiving the solution to the request from the at least one crowd care tier, in compliance with the service level agreement; and
sending the solution to the customer.

12. The system of claim 11, wherein the request pertains to a troubleshooting issue for a product or service sold by the business to the customer.

13. The system of claim 11, wherein the plurality of crowd care tiers comprise:
a customer crowd tier consisting of customers of the business;
an online community crowd tier comprising individuals who are not customers of the business; and
a business representative tier consisting of employees of the business.

14. The system of claim 11, wherein the instructions further cause to processor to receive informational inputs and append the informational inputs to the request before routing the request to the at least one crowd care tier.

15. The system of claim 11, wherein the instructions further cause the processor to receive information from the customer about whether the solution sent to the customer resolved the request.

16. The system of claim 15, wherein the instructions further cause the processor to:
update a knowledge database with the information received from the customer and the solution to the request received from the at least one crowd care tier; and
use the knowledge database to aid in resolving future requests from other customers.

17. The system of claim 11, wherein the instructions further cause the processor to reward individuals in the at least one crowd care tier who submit solutions to the request, with points that may be redeemed for discounts on products or services offered by the business.

18. The system of claim 11, wherein the instructions further cause the processor to define a level of expertise and/or experience required for membership in each of the plurality of crowd care tiers.

19. The system of claim 18, wherein the instructions further cause the processor to provide training and/or testing opportunities to advance from one crowd care tier requiring a first level of expertise to a second crowd care tier requiring a second level of expertise greater than the first level of expertise.

20. The system of claim 11, wherein the instructions further cause the processor to refine the request before routing the request to the at least one crowd care tier.
